(19) United States
(12) Patent Application Publication
(10) Pub. No.: US 2009/0256679 A1
(43) Pub. Date: Oct. 15, 2009

(54) RFID BASED METHODS AND SYSTEMS FOR USE IN MANUFACTURING AND MONITORING APPLICATIONS

(75) Inventors: Radislav Alexandrovich Potyrailo, Niskayuna, NY (US); William Guy Morris, Rexford, NY (US); Cheryl Margaret Surman, Albany, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/329,001

(22) Filed: Dec. 5, 2008

Related U.S. Application Data
(60) Provisional application No. 61/044,305, filed on Apr. 11, 2008.

(51) Int. Cl. H04Q 5/22

(52) U.S. Cl. 340/10.1

(57) ABSTRACT

Methods and systems for optimizing information associated with RFID devices that, include a memory chip written with redundant data and read by an RFID reader and, are adapted for operation of RFID tags and chemical, biological, and physical RFID sensors that are exposed to gamma radiation, such as disposable devices used in bioprocessing.

### CROSS REFERENCE TO RELATED APPLICATIONS

This application is a continuation-in-part of U.S. Provisional Patent Application Ser. No. 61/044,305 entitled “RFID Reader and Associated Components For RFID Tags and Sensors Exposed To Radiation”, filed Apr. 11, 2008, which is herein incorporated by reference.

### BACKGROUND

The invention relates generally to RFID based methods and systems for use in manufacturing and monitoring applications. These methods and systems feature RFID readers and devices designed to optimize information associated with the RFID device.

RFID tags are widely employed for automated identification of animals, tagging of garments, labels, and combinatorial chemistry reaction products, and detection of unauthorized opening of containers. For these and many other applications, the attractiveness of conventional passive RFID tags stems from their low cost. For sensing applications such as temperature, pressure, and some others, far more sophisticated RFID sensors have been more recently developed.

These RFID sensors enable a new platform manufacturing technology for processing systems, such as pharmaceutical processing. For example, RFID sensors can be embedded into disposables from key operations in pharmaceutical production process such as bioreactors, mixing, product transfer, connection, disconnection, filtration, chromatography, centrifugation, storage, and filling. For these diverse needs, disposable RFID sensor systems are needed to enable the in-line manufacturing monitoring and control. RFID systems have been recently developed for wireless sensing applications.

In addition, authentication of bioprocess components is performed to prevent illegal use of the disposable bioprocess components, to prevent illegal operation of the disposable bioprocess components, and to prevent illegal pharmaceutical manufacturing. RFID devices are often employed for such product authentication. The benefits of RFID compared to old authentication technologies include non line-of-sight reading, item-level identification, non-static nature of security features, and cryptographic resistance against cloning. RFID systems in general comprise RFID tags, readers, and online databases.

However, the most prominent limitation of these systems is the inability to calibrate the sensors and verify the information written and stored on the memory chips in the RFID devices. For example, processes that involve biological and biomedical materials and devices require components that can be sterilized using gamma radiation. Yet, conventional RFID devices are not resistant to gamma radiation, thus they either cannot store digital information after gamma sterilization or the information is often times corrupted by the radiation.

To overcome such limitations, improvements to RFID devices and systems are needed.

### BRIEF DESCRIPTION

The methods and systems of the invention are designed to overcome the limitations of previous RFID devices. For example, the methods and systems may be adapted for operation of chemical, biological, and physical RFID sensors in gamma radiation sterilized environment of disposable bioprocess manufacturing. RFID reader/writer devices are essential for reliable operation of gamma sterilizable RFID tags and sensors, such as the tags and sensors that are incorporated into disposable bioprocess components.

The methods and systems of the invention are adapted to verify various types of information associated with an RFID device using, at least in part, an RFID reader to read the information stored on a memory chip in the RFID device.

One or more of the embodiments of the methods and systems of the invention comprises one or more of the following functions: (1) automated writing of redundant data into memory chip; (2) scanning power capability to most reliably detect and authenticate the RFID tag and to provide the most reliable data stored in the user portion of the memory chip; (3) distance control to read the RFID tags where distance control is a provision to have a reproducible gap between the tag and the reader; (4) auto-redundancy reduction after gamma irradiation; (5) capability to determine if the RFID tag has been gamma irradiated, the level radiation exposure and the time elapse since exposure to radiation; and the (6) capability to determine if the disposable biocomponent that has an incorporated RFID tag has been gamma irradiated.

The methods and systems of the invention may also be used to authenticate the RFID tag, sensor or component (e.g. biocomponent) into which the RFID device is incorporated.

An example of the method of the invention for optimizing information associated with an RFID device at least in part using an RFID reader, wherein the RFID device comprises a memory chip written with at least one redundant set of data; generally comprises: reading at least a portion of at least one the redundant data sets on the memory chip of the RFID device; and comparing at least the portion of the redundant data set read from the chip with another set of data on the chip. The step of comparing may comprise determining whether the RFID device has been exposed to radiation by determining that at least part of the data on the chip is corrupted. If the data is corrupted, then at least part of the corrupted data may be corrected. The RFID device may comprise an RFID tag and/or an RFID sensor.

The RFID reader may also be located a predetermined distance from the RFID device, so that, it can be determined whether a post-reading distance between the RFID reader and the RFID device varies from the predetermined distance; and, if so, the power level of the reader is adjusted relative to the variance in distance.

The method may further comprise authenticating the RFID device at least in part based on the step of comparing the redundant data read from the chip. The method may also comprise determining whether part of the data on the chip is corrupted, by evaluating one or more performance characteristics of one or more CMOS components of the memory chip.

Once the data is verified and/or any corruption corrected, the method may further comprise deleting one or more whole or partial redundant sets of data in the memory of the chip.

One or more of the embodiments of the system of the invention for optimizing information between RFID components, generally comprises: an RFID device comprising a memory chip written with at least one redundant set of data; an RFID reader; and an operating subsystem that initiates the reader to scan at least a portion of the redundant data sets on the memory chip of the RFID device; and facilitates one or more of the determinations of the methods of the invention.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic drawing of an embodiment of the reader and an associated gamma radiation-resistant RFID tag of the invention.

FIG. 2 is an illustration of two embodiments of an RFID reader at a predetermined distance from an RFID device incorporated into a component.

FIG. 3 is a graph of the number of bytes correctly read from four RFID devices, two of which were irradiated and two that were not irradiated.

FIG. 4 includes four graphs of the number of bytes correctly read from four devices, two of which were irradiated and two of which were not irradiated, relative to the distance between each tag and the reader: (A) devices A and B before gamma irradiation, shorter distance; (B) devices A and B before gamma irradiation, longer distance; (C) devices C and D after gamma irradiation, shorter distance; (D) devices C and D after gamma irradiation, longer distance.

FIG. 5 illustrates an example of the reader to device distance as it relates to the gamma irradiated and non-irradiated RFID devices.

FIG. 6 is a graph of an example of the relationship between the reader-device distance and the number of the correct bytes.

FIG. 7 is a graph of an example of the relationship between the reader-device distance and the number of the correct bytes after comparing redundant data for each sector A, B, and C.

FIG. 8 is an illustration of an embodiment of a FRAM based memory chip showing redundant data written into three sectors and the FRAM based memory chip after redundant data is released from the sectors.

FIG. 9A shows graphs of an example of redundant pages read from the 2000 bytes memory data from RFID tags of type B (n=7) as a function of applied interrogator power before (A) and after (B) gamma irradiation.

FIG. 9B shows graphs of an example of redundant pages read from the 2000 bytes memory data from RFID tags of type C (n=2) as a function of applied interrogator power before (A) and after (B) gamma irradiation.

FIG. 9C shows graphs of an example of redundant pages read from the 2000 bytes memory data from RFID tags of type A (n=7) as a function of applied interrogator power before (A) and after (B) gamma irradiation.

### DETAILED DESCRIPTION

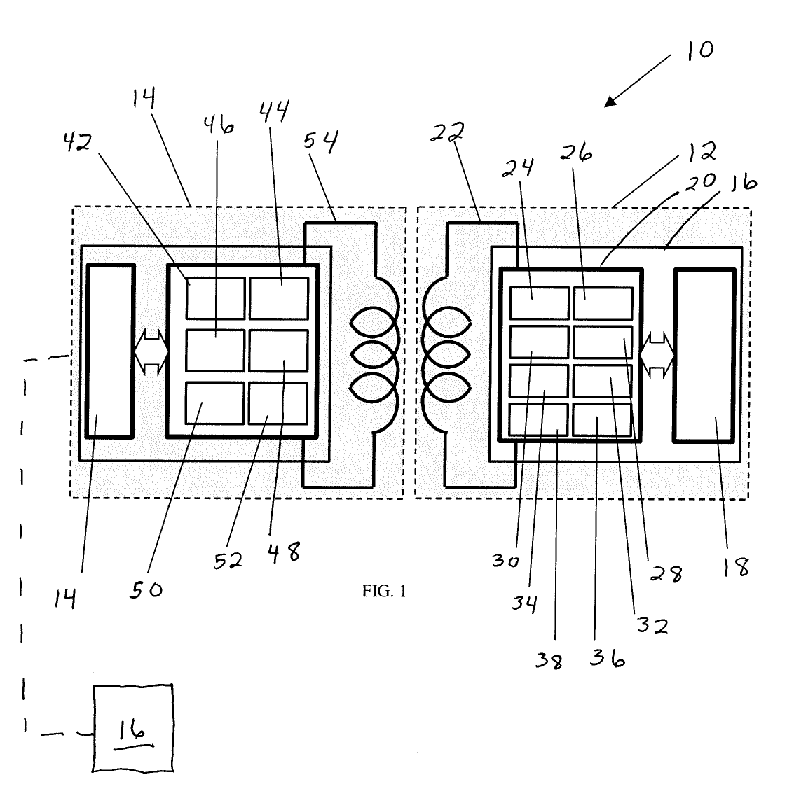

An embodiment of the system of the invention for verifying information associated with an RFID device is generally shown and referred to in FIG. 1 as system 10. System 10 generally comprises RFID device 12, RFID reader 14 and operating subsystem 16. RFID device 12 comprises a gamma resistant memory chip 16. Chip 16 comprises a non-volatile memory component 18, a CMOS device 20 and an antenna 22. The CMOS device 20 comprises various components such as rectifier 24, clock generator 26, anti-collision function controller 28, power supply voltage controller 30, data input/output controller 32, modulator 34, FRAM access controller 36 and demodulator 38. The RFID reader 14 comprises control device 40 (comprises a signal coding protocol), modulator 42, output module 44, oscillator 46, band pass filter 48, demodulator 50, amplifier 52 and antenna 54.

System 10 may be configured to carry out the methods for optimizing information associated with an RFID device. Following are a few non-limiting examples of the methods in which the RFID device comprises a memory chip on which data is written and the reader scans or otherwise reads the written data and the data, read by the reader from the RFID device's memory chip, is compared with redundant data or otherwise analyzed to determine whether the data has been corrupted or otherwise altered. From this analysis, the methods and systems are then adapted to automatically verify the data, make adjustments or corrections to the data on the memory chip, and/or make adjustments or corrections to one or more of the components of the system, to optimize the use of the information associated with the RFID device.

One example of the method is adapted for correcting information errors in the memory chip of the RFID device comprises: writing error-correctable information to a ferroelectric random memory (FRAM) portion part of a memory chip of the RFID tag that is attached to a single-use functional disposable bioprocess component; scanning the single-use functional bioprocess component to extract the information from the memory of the chip after the single-use functional bioprocess component with the RFID tag has been gamma irradiated for sterilization; and applying error-correction steps to improve the reliability of extracted information.

Another example of the method is adapted for authenticating the RFID device and/or the component, such as a bioprocess component, comprises: writing error-correctable information to FRAM portion part of a memory chip of the RFID tag that is attached to a single-use functional disposable bioprocess component; scanning the single-use functional bioprocess component to extract the information from the memory of the chip after the single-use functional bioprocess component with the RFID tag has been gamma irradiated for sterilization; applying error-correction steps to improve the reliability of extracted information; and authenticating the functional bioprocess component with the RFID tag. After authentication, the RFID device and/or the bioprocess component is cleared for its intended functional operation or use.

Another example of the method is adapted to determine whether the RFID device has or has not been irradiated with gamma radiation and, in some instances determines the amount of radiation exposure, by determining the minimum and maximum amount of power needed to read the memory chip of the device, or by determining the minimum and maximum distance between the RFID device and RFID reader to optimally read the tag.

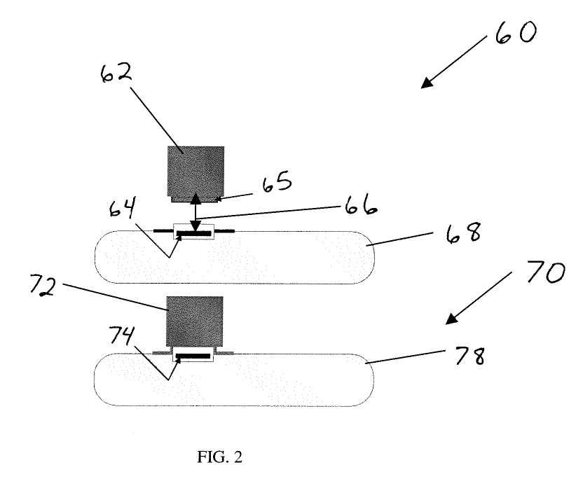

In at least one example, the distance between the RFID tag and RFID reader is established as a constant. This constant distance provides a baseline for eliminate possible read errors associated with radiation effects on the complementary metal-oxide semiconductor (CMOS) structure of the memory chip. Two embodiments are illustrated in FIG. 2. System 60 comprises RFID reader 62, RFID reader alignment flange 65, and RFID device 64 integrated into a process component 68. Reader 62 has an established distance constant illustrated by arrow 66. System 70 comprises an RFID reader 72, and RFID device 74 integrated into a process component 78. Reader 72 is fixed in direct contact with RFID device 74 and has an effective established distance constant of zero.

In a more application specific example of the methods, the RFID device is authenticated and redundant information is partially released from the device's memory. The method generally comprises: providing a disposable bioprocess component into which an RFID device is integrated, wherein the RFID device comprises a FRAM chip onto which error-correctable information is written and after the disposable bioprocess component is sterilized; introducing the disposable component in a bioprocessing system comprising an RFID reader; reading the information written on the RFID device; determining if the disposable bioprocess component is authentic based on at least a portion of the information read by the reader; and partially releasing redundant digital data on the memory chip of RFID device after the information on the memory chip is authenticated. Partial release of redundant digital data involves release of some of the redundant data while some of data is kept stored for subsequent use. The release of data after gamma sterilization becomes possible because gamma sterilization adversely affects and corrupts the RFID tag. Once this step is passed, the data redundancy is reduced.

The RFID device is fabricated with a memory chip that comprises both a CMOS circuitry and a FRAM circuitry. The device is then integrated into a process component and the memory chip of the device is initialized by applying an RF signal to the CMOS circuitry and writing redundant information to a plurality of regions in the FRAM circuitry of the memory chip of the RFID device. The device, depending on the intended use may then be sterilized along with the process component into which the device is integrated. Once the process component is introduced into a processing system, the device is then authenticated using the methods and systems. Once the device is authenticated, then the redundant or otherwise unnecessary data on the memory chip is deleted to free up the available memory from the redundant memory blocks for use by the end-user.

The memory chip of the RFID device may be fabricated with a radiation-hardened CMOS structure memory chip and a non-volatile memory and may further comprise a FRAM circuitry. The device's memory chip may be initialized by applying an RF signal to the CMOS circuitry and writing redundant information to a plurality of regions in FRAM portion of the memory chip. After the device sterilized with gamma radiation and integrated into a process component, the CMOS circuitry may be recovered after the gamma radiation, authenticated, and if the data is corrupted by the radiation, the data may be corrected using the redundant information.

The writing of redundant information to a plurality of regions in FRAM part of the memory chip of the RFID device may be accomplished by sending redundant information into the RFID device or sending information only once to the RFID device and sending the number of desired redundancy; and the memory chip configured to write redundant information into memory blocks. The process component may then be sterilized and introduced into a processing system. Prior to processing, the redundant information on the chip is read from a plurality of regions in FRAM part of the memory chip of the RFID tag. The reading is from the redundant memory blocks and the read data is compared with the information from redundant blocks. After comparison, select redundant information is released. Gamma radiation adversely affects and corrupts the RFID tag on the device level and on the material level. “Adverse effects” and “corruption” by gamma irradiation mean that the device continues to function however, with unintended noticeable variation from its performance before gamma irradiation. Data corruption refers to errors or alterations in data that occur during data retrieval, introducing unintended changes to the original data. Data loss refers to unrecoverable data unavailability due to hardware or software failure. To use the memory chip device of an RFID tag for authentication of a gamma-sterilized disposable bioprocess component, tone should address: (1) limitations of the non-volatile memory material such as ferroelectric memory material and any other non-charge-based storage memory material and (2) limitations of the CMOS circuitry of the memory chip as a whole device upon exposure to gamma radiation.

On the material level, it is known that while FRAM is more gamma radiation resistant than EEPROM (Electrically Erasable Programmable Read-Only Memory), it still experiences gamma-irradiation effects. The common gamma radiation sources are cobalt-60 (Co⁶⁰) and cesium-137 (Cs¹³⁷) isotopes. The cobalt 60 isotope emits gamma rays of 1.17 and 1.33 MeV. The cesium 137 isotope emits gamma rays of 0.6614 MeV. This energy of the gamma radiation for the Co⁶⁰ and Cs¹³⁷ sources is high enough to potentially cause displacement damage in the ferroelectric material. Indeed, after an exposure to a gamma radiation, FRAM experiences the decrease in retained polarization charge due to an alteration of the switching characteristics of the ferroelectric due to changes in the internal fields. This radiation-induced degradation of the switching characteristics of the ferroelectric is due to transport and trapping near the electrodes of radiation-induced charge in the ferroelectric material. Once trapped, the charge can alter the local field around the dipoles, altering the switching characteristics as a function of applied voltage. Two known scenarios for trap sites are at grain boundaries or in distributed defects in the ferroelectric material, depending on the fabrication method of FRAM (for example, sputtering, sol-gel deposition, spin-on deposition, metal-organic chemical vapor deposition, liquid source misted chemical deposition). In addition to the charge trapping, gamma radiation can also directly alter the polarizability of individual dipoles or domains.

On the device level, the FRAM memory chip of the RFID tag comprises a standard electric CMOS circuit and an array of ferroelectric capacitors in which the polarization dipoles are temporarily and permanently oriented during the memory write operation of the FRAM. On the device level, the FRAM device has two modes of memory degradation that include functional failure and stored data upset. Thus, the radiation response effects in the memory chip are a combination of non-volatile memory and the CMOS components in the memory chip. Radiation damage in CMOS includes but is not limited to the threshold voltage shift, increased leakage currents, and short-circuit latchup.

In conventional CMOS/FRAM memory devices, the gamma radiation induced loss of device performance (the ability to write and read data from the memory chip) is dominated by the unhardened commercial CMOS components of memory chip. Hardened-by-design techniques can be used to manufacture radiation-hardened CMOS components of semiconductor memory. The examples of hardened-by-design CMOS components include p-channel transistors in memory array, annular n-channel gate structures, p-type guard rings, robust/redundant logic gates protecting latches, latches immune to single event effects (SEE), and some others. The hardened-by-design techniques prevent radiation-hard latches from being set by single event transients (SET) propagating through the logic of the device.

For applications in which the RFID device comprises a sensor, the memory chip of the RFID device may be initialized by applying RF signal to the CMOS circuitry and writing error-correctable information to FRAM part of the memory chip of the RFID sensor where information contains calibration parameters of the sensor. These parameters can then be used to authenticate and/or calibrate the information associated with the RFID sensor. The sensor may be adapted for use as a physical, chemical and/or biological sensor. Authentication may or may not, depending on the use, comprise RFID sensor initialization and a change of its reading.

The RFID reader may read the memory chip of the RFID device at different power level, at different distances between the reader and the RFID tag, or at different modulation depths of the RF signal. Non-limiting examples of applicable power levels of the RFID reader are from 1 mW to 10000 mW, more preferable from 2 mW to 1000 mW, more preferable from 5 mW to 500 mW. Non-limiting examples of modulation depth of RF wave carrier of the RFID reader is from 0 to 100%, more preferable from 2 to 80%, more preferable from 5 to 50%. A non-limiting example of the bit rate of the RFID reader is 20-30 kbps.

The following examples are provided for illustration only and should not be construed as limiting.

### EXAMPLES

RFID tags operating at a nominal frequency of 13.56 MHz were fabricated with memory chips MB89R118A (Fujitsu Corp., Japan) attached to 5.5×8.5 cm antenna. These memory chips are made using a standard 0.35 micrometers CMOS circuitry process coupled with a process of manufacturing ferroelectric memory. Writing and reading of data was performed using a computer-controlled multi-standard RFID Reader/Writer evaluation module (Model TRF7960 Evaluation Module, Texas Instruments) and a reader/writer 111 from Wave Logic LLC (Scotts Valley, Calif.).

### Example 1

The total available 2000 bytes memory of memory chips was divided into three sectors such as a sector A for article ID, serial number, and possible sensor calibrations, sector B for authentication, and sector C with user available blocks. Redundant data was written into two sectors (A and B). The sectors A, B, and C were unencrypted data, encrypted data, and empty (no data), respectively. The respective page redundancy was 11, 9, and 5, thus we had 25 pages (11+9+5=25) of 80 bytes per page. The goal was to write redundant data, gamma irradiate the tags, read the data back, and count the number of pages that were correct after the irradiation. An algorithm compared the content of each page and highlighted the page that had a content that did not match with the majority of similar pages.

One of pages A was corrupted after gamma irradiation (35 kGy) in one tag out of 13 tags. However, because the majority of similar pages had identical data, the overall data was correctly identified. As a result of the redundant data writing onto ferroelectric memory, each tag out of 13 tested tags was correctly read and thus, all tags passed the gamma irradiation test, although one page (80 bytes) was corrupted by gamma radiation.

### Example 2

As another example, the improvement of reliability of writing and reading data onto RFID tags after their gamma irradiation was demonstrated. Before irradiation the read range of the tested RFID tags with memory chips based on CMOS circuitry and ferroelectric memory was from 10 to 50 mm from the reader. Immediately after irradiation with 35 kGy of gamma rays, the read range became very narrow, 20-21 mm from the reader. The read range became 12-30 mm after 2 weeks after gamma irradiation. The read range found after irradiation did not reach the initial read range after months after the irradiation. To read reliably the RFID tags after gamma irradiation the power level of the employed RFID reader was altered from its minimum to its maximum and the tag response was determined. To read reliably the RFID tags after gamma irradiation, the distance between the employed RFID reader and the RFID tag was altered from its minimum to its maximum distance before the tag gamma irradiation and the tag response was determined.

### Example 3

The release of additional memory blocks for the end-user after the gamma irradiation was demonstrated after the redundancy of written data was implemented. RFID tags 102 with ferroelectric memory and with redundant data were used as described in Example 1. After the irradiation, the data was read from the memory of ferroelectric memory chips. The correct data was established from the at least three identical pages. Thus, the rest of the pages were released for the end user.

### Example 4

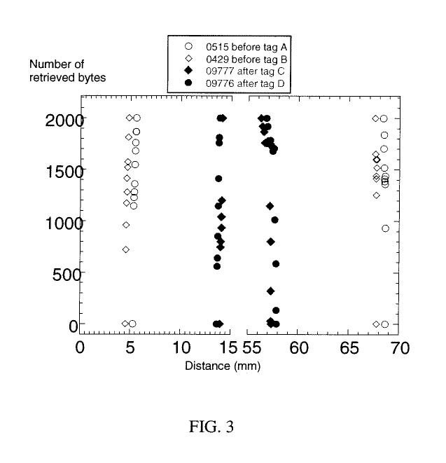

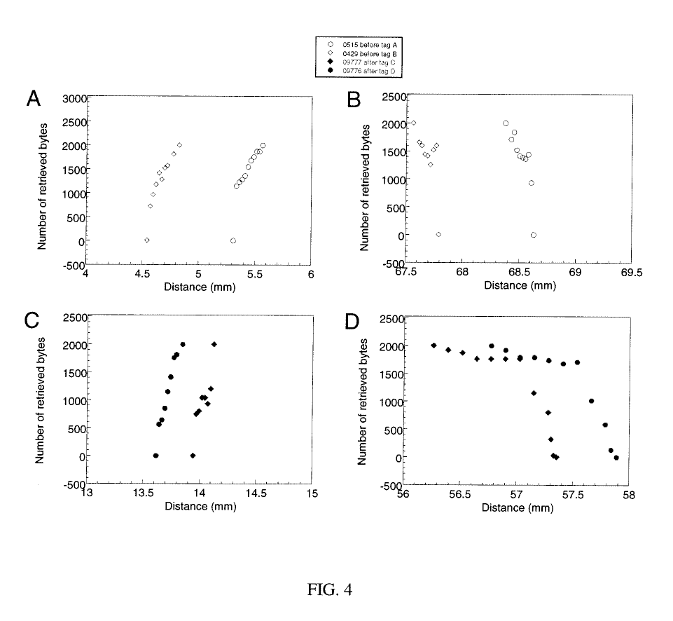

Gamma non-irradiated and irradiated RFID tags were measured to determine the number of retrieved bytes from each tag as a function of distance between the RFID reader and the tag. FIG. 3 and FIG. 4 illustrate that the number of retrieved bytes from the tags is related to the tag condition (irradiated or non-irradiated RFID tags). The distance between the RFID reader and the tag is related to the reader power delivered to the tag. The reader power was 100 mW.

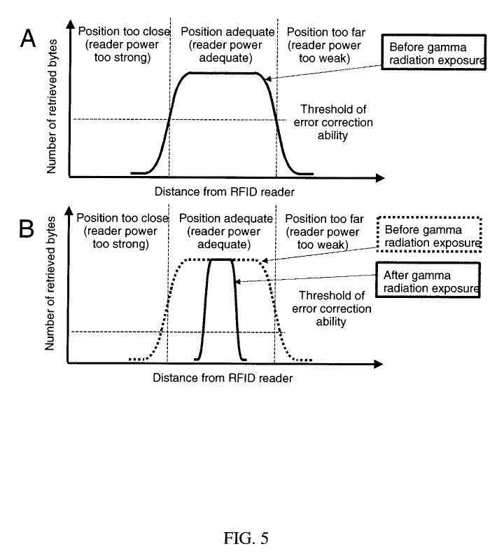

FIG. 5 illustrates the significance of relationships in gamma irradiated and non-irradiated RFID tags. A non-irradiated RFID tag responds to the RFID reader as shown in FIG. 5, graph A. If signal from the reader is too strong (position of the RFID tag is too close to the reader), the tag will not be read. If signal from the reader is too weak (position of the RFID tag is too far to the reader), the tag also will not be read. However, if signal from the reader is within an allowed range for the RFID tag to be accepted, the tag will be read. The read range for the gamma irradiated and non-irradiated RFID tags is tremendously different (see FIG. 5, graph B).

Thus, the reader reads the gamma-irradiated tags with the error-correction ability to read all (or most) the bytes from memory. This distance (or reader power) dependence may also serve to provide: capability to determine if the RFID tag has been gamma irradiated; and capability to determine if the disposable biocomponent that has an incorporated RFID tag has been gamma irradiated.

### Example 5

A gamma irradiated RFID tag was measured at different power levels available to the tag (as distances from the reader to the tag with reader power of 100 mW). The total available 2000 bytes memory of memory chips was divided into three sectors such as a sector A for article ID, serial number, and possible sensor calibrations, sector B for authentication, and sector C with user available blocks. Redundant data was written into two sectors (A and B). The sectors A, B, and C were unencrypted data, encrypted data, and empty (no data), respectively. The respective page redundancy was 11, 9, and 5, thus we had 25 pages (11+9+5=25) of 80 bytes per page. The intent was to write redundant data, gamma irradiate the tags, read the data back, and count the number of pages that were correct after the irradiation. An algorithm may be used to compare the content of each page and highlighted the page that had a content that did not match with the majority of similar pages.

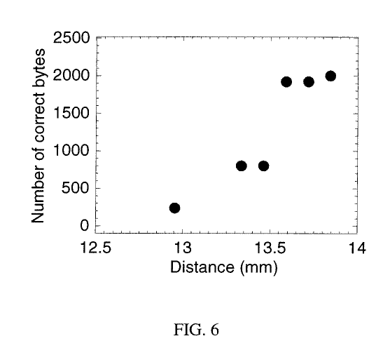

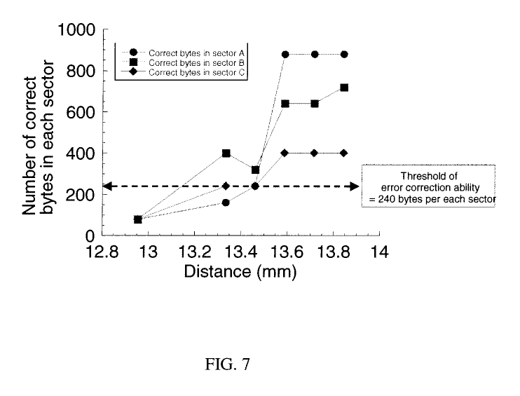

The dependence of the number of correct pages was related to the power available from the reader. This available power was related to the reader-tag distance. Table 1 shows the relation between the reader-tag distance and the number of correct pages after gamma irradiation of the tag. FIG. 6 shows the relation between the reader-tag distance and the number of the correct bytes as identified from redundant data. The threshold of error correction ability was determined as a minimum of three pages per sector A, B, and C. Thus the total number of bytes that determined the threshold of error correction ability in this case was 3*80+3*80+3*80=720. However, the more appropriate approach is to determine the threshold of error correction ability per each sector (if sectors employed in data writing) because even when the total threshold was 720 bytes, it was observed an a non-correctable error in sector A (only 2 pages were correct out of required 3) but 5 pages were correct in sector B, and 3 pages were correct in sector C, making total number of correct bytes 800. Thus for the more appropriate approach, the threshold of error correction ability per each sector was 3*80=240 bytes (see FIG. 7).

TABLE 1

| | | Correct | | Correct | | Correct | Total |
|---|---|---|---|---|---|---|---|
| | | bytes in | | bytes in | | bytes in | correct |
| Distance (mm) | Sector A | sector A | Sector B | sector B | Sector C | sector C | bytes |
| 13.843 | 11 | 880 | 9 | 720 | 5 | 400 | 2000 |
| 13.716 | 11 | 880 | 8 | 640 | 5 | 400 | 1920 |
| 13.589 | 11 | 880 | 8 | 640 | 5 | 400 | 1920 |
| 13.462 | 3 | 240 | 4 | 320 | 3 | 240 | 800 |
| 13.335 | 2 | 160 | 5 | 400 | 3 | 240 | 800 |
| 12.954 | 1 | 80 | 1 | 80 | 1 | 80 | 240 |

Storage of required digital information that allows the error correction of this information can be accomplished using known methods. Non-limiting examples of these methods include, but are not limited to, redundancy, Reed-Solomon error correction (or code), Hamming error correction (or code), BCH error correction (or code), and others known in the art.

Data redundancy is achieved by writing multiple copies of the data into memory so as to protect them from memory faults. Writing multiple copies of the data into the memory or writing redundant information on a FRAM chip of the RFID tag means writing information into plurality of regions on the memory chip. The goal of writing redundant information on a FRAM chip of the RFID tag is to reduce gamma irradiation effect that otherwise can cause loss of at least portion of data that will lead to the failure to authenticate a disposable bioprocess component attached to the RFID tag. The Reed-Solomon error correction is the method used for detecting and correcting errors as described in U.S. Pat. Nos. 4,792,953 and 4,852,099. This error correction method was used for example, in compact disks and digital videodisks. To detect and correct errors in data from RFID tags, the data to be written is converted into Reed-Solomon codes by a computer algorithm and the codes are written to the RFID memory. When the codes are read back from the RFID memory, they are processed through a computer algorithm that detects errors, uses the information within the codes to correct the errors, and reconstructs the original data.

The Hamming error correction has been used in random access memory (RAM), programmable read-only-memory (PROM) or read-only-memory as detailed in U.S. Pat. No. 4,119,946. By using the Hamming error correction to RFID memory, the data to be stored in RFID memory is processed by an algorithm where it is divided into blocks, each block is transformed to a code using a code generator matrix, and the code is written to the RFID memory. After the code has been read back from the RFID memory, it is processed using an algorithm that comprises a parity-check matrix that can detect single-bit and double-bit errors, but only the single bit errors can be corrected.

The Bose-Chaudhuri-Hocquenghem (BCH) error correction is a polynomial code over a finite field with a particularly chosen generator polynomial, see for example U.S. Pat. No. 4,502,141. The data to be stored in RFID memory is transformed to a code by using an algorithm based on a generator polynomial, and the code is written to the RFID memory. After the code has been read back from the RFID memory, it is processed using an algorithm that includes calculating roots of a polynomial to locate and correct errors. The Reed-Solomon code can be considered a narrow-sense BCH code.

### Example 6

Exposure to gamma radiation often negatively affects the reliable operation of the gamma-irradiated RFID tags. To improve the reliability of reading digital data onto RFID tags, at the stage of fabrication of a single-use bioprocess component, relevant manufacturer data is written into the memory of the IC chip with a high level of redundancy. After the gamma irradiation, the tag is interrogated to read the stored data, to reduce the level of redundancy, and to release the appropriate memory for the end-user.

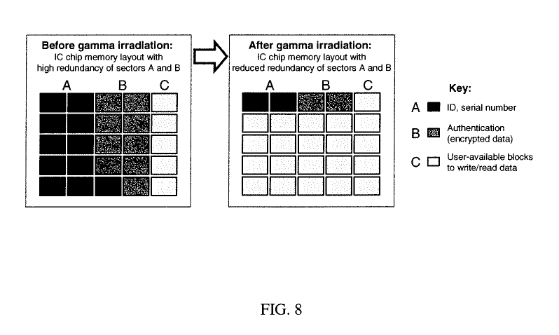

An example of several steps of the method for reducing the risk of data loss upon gamma irradiation of RFID tags is illustrated in FIG. 8. The available memory (2000 bytes on a MB89R118A chip) is divided into the three sectors. Sector A contains manufacturer product information about single-use components (ID, serial number, etc.). Sector B contains information for the tag authentication. Sector C has initial user-available blocks. When an RFID tag is integrated with a single-use biocomponent, redundant data is written into sectors A and B. This redundancy reduces the risk of damage of data on the chip during the gamma irradiation. After gamma irradiation, the data is examined with the RFID interrogator and the data redundancy is reduced to free up the memory for the end-user.

### Example 7

Effects of the output power of the RFID interrogator on the reliability of data reading before and after gamma irradiation of RFID tags were studied. The FRAM memory chips MB89R118A were integrated into RFID tags with three antenna geometries (tag types A, B, and C). Type A of an RFID tag had a 10-mm diameter antenna; type B of an RFID tag had a 4.5×7.5 cm antenna; and type C of an RFID tag had a 2.2-cm diameter antenna.

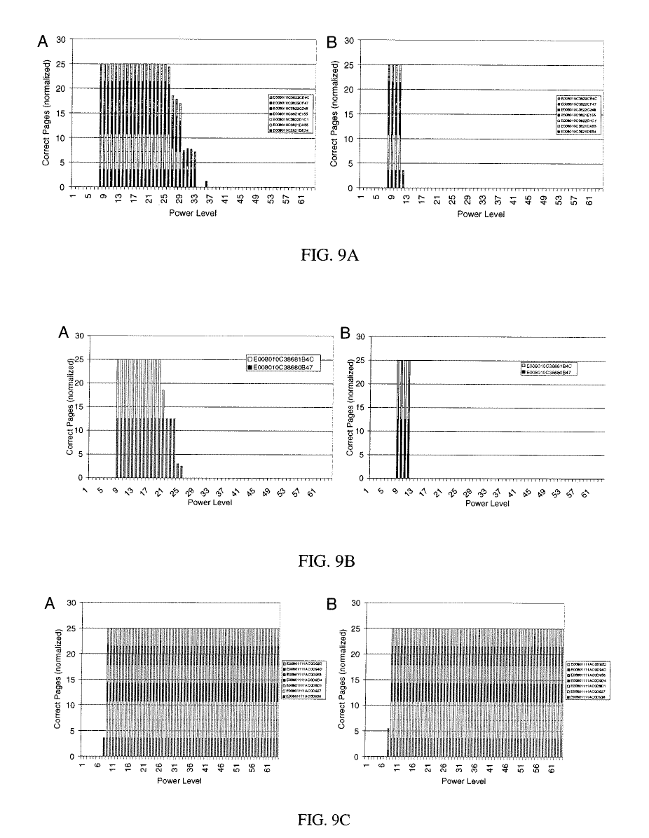

FIG. 9A shows the results of reading of the 25 pages with redundant 80 bytes of data per page from several (n=7) RFID tags with a 4.5×7.5 cm antenna (tag type B) as a function of applied power from the RFID interrogator (0-100 mW). The RFID tags were kept at a constant position against the RFID interrogator (direct tag/interrogator contact). These results demonstrate that the gamma irradiation (gamma dose=35 kGy) significantly changes the power read range of these RFID tags. At a given tag/interrogator distance, the power range at which the tags were reliably read was 8-33 before gamma irradiation. The power range has significantly narrowed down to 8-13 after gamma irradiation. This narrowing of the range is associated with radiation-induced changes in the performance of CMOS structure of the IC memory chip. Similar narrowing of power range useful for tag interrogation after the gamma irradiation of the tags was observed at a distance that was approximately the size of the tag in one dimension (4.5 cm). At that relatively large distance, the power range at which the tags were reliably read was 64-13 before gamma irradiation and was reduced down to 64-40 after gamma irradiation.

Effects of the output power of the RFID interrogator on the reliability of data reading before and after gamma irradiation of RFID tags were studied with tags of type C (antenna size=2.2. cm diameter). FIG. 9B shows the results of reading redundant pages from the 2000 bytes memory data from RFID tags of type C (n=2) as a function of applied interrogator power before (A) and after (B) gamma irradiation, where the interrogator power range is between 0-100 mW; the gamma dose is 35 kGy; RFID/interrogator distance is essentially zero (direct contact); and the antenna is 2.2 cm in diameter. The applied power from the RFID interrogator was varied from 0 to 100 mW on a scale from 0 to 64 relative units (RU). FIG. 9B demonstrates that the gamma irradiation also significantly changes the power read range of RFID tags of type C. Similar narrowing of power range useful for tag interrogation after the gamma irradiation of the tags was observed at a distance that was approximately the size of the tag in one dimension (2 cm).

This significant negative effect observed for tags types B and C has been addressed in the developed gamma resistant RFID tags (tag type A). FIG. 9C shows the results of reading redundant pages from the 2000 bytes memory data from RFID tags of type A (n=7) as a function of applied interrogator power before (A) and after (B) gamma irradiation. The interrogator power range is 0-100 mW; the gamma dose is about 35 kGy; the RFID tag and reader are in direct contact; and the antenna is 10 mm diameter. Measurement conditions included power scans from 0 to 100 mW and variation of read distance from the contact to the distance equal to the size of the tag. It was found that the gamma irradiation did not detectably change the power read range of these new RFID tags when these tags were kept at a constant position against the RFID interrogator (direct tag/interrogator contact). Evaluation of distance dependence of the read quality of 10-mm diameter tags after gamma irradiation was also studied. It was found that unlike tags of types B and C, the power range useful for tag interrogation after the gamma irradiation of the tags was not altered at various distances, up to the distance that was approximately the size of the tag in one dimension (10 mm).

The memory chip may comprise a complementary metal-oxide semiconductor (CMOS) chip with a ferroelectric random access memory (FRAM). Memory chip comprises the (CMOS) chip or CMOS circuitry and the FRAM circuitry as a part of the RFID tag or device incorporated into a disposable bioprocess component and preventing its unauthorized use. The examples of the CMOS circuitry components include a rectifier, a power supply voltage control, a modulator, a demodulator, a clock generator, and other known components. The memory chip that includes a CMOS circuitry and a digital FRAM circuitry is referred to herein as “FRAM memory chip”. To achieve ability to use the memory chip device of an RFID tag for authentication of a gamma-sterilized disposable bioprocess component, it is critical to address: (1) limitations of the non-volatile memory material such as ferroelectric memory material and any other non-charge-based storage memory MATERIAL and (2) limitations of the CMOS circuitry of the memory chip as a whole DEVICE upon exposure to gamma radiation.

A few examples of non-volatile memory, known in the art, that may be used in one or more of the methods and devices are Giant Magneto-Resistance Random Access Memory (GMRAM), Ferroelectric Random Access Memory (FRAM), and Chalcogenide Memory (GM). Examples of are further described in Strauss, K. F.; Daud, T., Overview of radiation tolerant unlimited write cycle non-volatile memory, IEEE Aerospace Conf. Proc. 2000, 5, 399-408.

A few examples of materials that can be used to create ferroelectric memory include potassium nitrate (KNO₃), lead zirconate titanate (PbZr₁₋ₓTiₓO₃, usually abbreviated as PZT), Pb₅Ge₃O₁₁, Bi₄Ti₃O₁₂, LiNbO₃, SrBi₂Ta₂O₉, and others. In ferroelectric memory, the ferroelectric effect is characterized by the remnant polarization that occurs after an electric field has been applied. The unique chemical atomic ordering of ferroelectric materials allows a center atom in the crystal lattice to change its physical location. The center atom in a cubic PZT perovskite crystal lattice will move into one of the two stable states upon an external applied electric field. After the external electric field is removed, the atom remains polarized in either state; this effect is the basis of the ferroelectric as a nonvolatile memory. An electric field can reverse the polarization state of the center atom, changing from a logic state “0” to “1” or vice versa. This nonvolatile polarization, which is the difference between the relaxed states (the charge density), is detected by the detector circuitry. FRAM is a type of memory that uses a ferroelectric material film as a dielectric of a capacitor to store RFID data. A few non-limiting examples of memory chips include FRAM chips for 13.56 MHz such as of the FerVID Family™ and are MB89R111 (ISO14443, 2 Kbyte), MB89R118 (ISO15693, 2 Kbyte), MB89R119 (ISO15693, 256 byte) available from Fujitsu located at 1250 East Arques Avenue, Sunnyvale, Calif. 94085.

A few examples of sources for FRAM memory chips includes Ramtron International Corporation (Colorado Springs, Colo.), Fujitsu (Japan), Celis Semiconductor (Colorado Springs, Colo.), and others. The RFID tag that contains the FRAM memory chip can also be converted into RFID sensor as described in U.S. patent application numbers US 2007-0090926, US 2007-0090927, and US 2008-0012577, which are hereby incorporated by reference.

One or more of the embodiments of the RFID reader may be used to authenticate the RFID tag of the disposable component. Product authentication using RFIDs can be based on RFID tag authentication or identification and additional reasoning using online product data. Furthermore, RFID supports for secure ways to bind the RFID tag and the product. Cloning and forgery are the most important security risks necessitating authentication of the RFID tags.

There are several RFID product authentication approaches. One product authentication approach is unique serial numbering. By definition, one of the fundamental assumptions in identification, and thus also in authentication, is that individual entities possess an identity. In supply chain applications, issuing unique identities is efficiently accomplished with RFID. There is a unique serial numbering and confirmation of validity of identities as the simplest RFID product authentication technique. The simplest cloning attack against an RFID tag only requires the reader reading the tag serial number and programming the same number into an empty tag. However, there is an essential obstacle against this kind of replication. RFID tags have a unique factory programmed chip serial number (or chip ID). To clone a tag's ID would therefore also require access to the intricate process of chip manufacturing.

Another product authentication approach is track and trace-based plausibility check. Track and trace refers to generating and storing inherently dynamic profiles of individual goods when there is a need to document pedigrees of the disposable bioprocess product, or as products move through the supply chain. The product specific records allow for heuristic plausibility checks. The plausibility check is suited for being performed by customers who can reason themselves whether the product is original or not, though it can also be automated by suitable artificial intelligence. Track and trace is a natural expansion of unique serial numbering approaches. Furthermore, track and trace can be used in supply chains for deriving a product's history and for organizing product recalls. In addition, biopharmaceutical industry has legislation that demands companies to document product pedigrees. Therefore, the track and trace based product authentication can be cost-efficient, as also other applications to justify the expenses.

Another product authentication approach is secure object authentication technique that makes use of cryptography to allow for reliable authentication while keeping the critical information secret in order to increase resistance against cloning. Because authentication is needed in many RFID applications, the protocols in this approach come from different fields of RFID security and privacy. In one scheme, it is assumed that tags cannot be trusted to store long-term secrets when left in isolation. Thus, the tag is locked without storing the access key, but only a hash of the key on the tag. The key is stored in an online database of the computer connected to the reader and can be found using the tag's ID. This approach can be applied in authentication, namely unlocking a tag would correspond authentication.

Another product authentication approach utilizes product specific features. In this approach the authentication is based on writing on the tag memory a digital signature that combines the tag ID number and product specific features of the item that is to be authenticated. These product specific features of the item that is to be authenticated can be response of the integrated RFID sensor. The sensor is fabricated as a memory chip with an analog input from a separate micro sensor. The sensor also can be fabricated as described in U.S. patent applications, Serial Nos. 20070090926, 20070090927, and 20080012577, which are hereby incorporated by reference. These features can be physical or chemical properties that identify the product and that can be verified. One or more of these selected features may be measured as a part of the authentication steps by the reader. For example, if the feature used in the tag's signature does not match the measured feature, the tag-product pair is not original. This authentication technique may use a public key stored on an online database that can be accessed by the computer connected to the measurement device. An offline authentication can be also used by storing the public key on the tag that can be accessed by the computer connected to the measurement device, though this may decrease the level of security.

Gamma resistant RFID tags and sensors facilitate the authentication of the disposable component onto which it is attached. Authentication involves verifying the identity of a user logging onto a network by using the measurement device and the reader and the disposable component or assembled component system. Passwords, digital certificates, and smart cards can be used to prove the identity of the user to the network. Passwords and digital certificates can also be used to identify the network to the client. The examples of employed authentication approaches include: Passwords (What You Know) and Digital certificates, physical tokens (What You Have, for example integrated RFID sensor with its response feature); and their combinations. The use of two independent mechanisms for authentication; for example, requiring a smart card and a password is less likely to allow abuse than either component alone.

One of the authentication approaches using the gamma resistant RFID tag on the disposable component involves mutual authentication between reader and RFID tag, which is based on the principle of three-pass mutual authentication in accordance with ISO 9798-2, in which a secret cryptographic key is involved. In this authentication method, the secret keys are not transmitted over the airways, but rather only encrypted random numbers are transmitted to the reader. These random numbers are always encrypted simultaneously. A random session key can be calculated by the measurement device and the reader, from the random numbers generated, to cryptologically secure the subsequent data transmission.

Another authentication method uses RFID tags with different cryptological keys. To achieve this, a serial number of each RFID tag is read out during its production. A unique key is further derived using a cryptological algorithm and a master key, and the RFID tag is thus initialized. Thus, each RFID tag receives a key linked to its own ID number and the master key.

RFID tags with unique serial numbers can be authenticated and also access lot information (e.g. date of manufacture, expiration date, assay results, etc.) from the device manufacturer. The serial number and lot information is transferred to a user accessible server once the product has been shipped. The user upon installation then reads the RFID tag that transmits the unique serial number to a computer with a secure Internet link to the customer accessible server. A match of the serial number on the server with the RFID tag serial number then authenticates the device and permits use of the device. Once the information is accessed on the server the information is then becomes user inaccessible to prevent reuse of a single use device. Conversely, if there is no match with a serial number the device cannot be used and is locked out from authentication and access of lot information.

To encrypt data for its secure transmission, the text data is transformed into encrypted (cipher) text using a secret key and an encryption algorithm. Without knowing the encryption algorithm and the secret key, it is impossible to recreate the transmission data from the cipher data. The cipher data is transformed into its original form in the receiver using the secret key and the encryption algorithm. Encryption techniques include private key cryptography and public key cryptography that prevent illegal access to internal information in the memory on the memory chip.

While only certain features of the invention have been illustrated and described herein, many modifications and changes will occur to those skilled in the art. It is, therefore, to be understood that the invention is intended to cover all such modifications and changes as fall within the true spirit of the invention.

1. A method for optimizing information associated with an RFID device at least in part using an RFID reader, wherein the RFID device comprises a memory chip written with at least one redundant set of data; comprising the steps of,
reading at least a portion of at least one the redundant data sets on the memory chip of the RFID device; and
comparing at least the portion of the redundant data set read from the chip with another set of data on the chip.

2. The method of claim 1, further comprising the step of comparing at least one of the redundant data sets read from the chip to eliminate effects of gamma radiation on the RFID device.

3. The method of claim 1, further comprising the step of, determining whether the RFID device has been exposed to radiation by determining that at least part of the data on the chip is corrupted.

4. The method of claim 3, further comprising the step of, correcting at least part of the corrupted data.

5. The method of claim 1, wherein the RFID reader is at a predetermined distance from the RFID device, further comprising the steps of, determining whether a post-reading distance between the RFID reader and the RFID device varies from the predetermined distance; and adjusting a power level of the reader based at least in part on a variation between the predetermined distance and the post-reading distance.

6. The method of claim 5, further comprising the step of, determining whether the RFID device has been exposed to radiation by determining that at least part of the data on the chip is corrupted.

7. The method of claim 1, further comprising the step of, determining whether at least part of the data on the chip is corrupted.

8. The method of claim 7, further comprising the step of, correcting at least part of the corrupted data.

9. The method of claim 1, determining whether at least part of the data on the chip is corrupted by evaluating one or more performance characteristics of one or more CMOS components of the memory chip.

10. The method of claim 1, further comprising the step of, adjusting a power level of the reader.

11. The method of claim 1, further comprising the steps of, deleting one or more whole or partial redundant sets of data in the memory of the chip.

12. The method of claim 1, wherein the RFID device is an RFID sensor.

13. The method of claim 1, wherein the RFID device is an RFID tag.

14. The method of claim 1, authenticating the RFID device at least in part based on the step of comparing the redundant data read from the chip.

15. A method for optimizing information associated with an RFID device at least in part using an RFID reader, wherein the RFID device comprises a memory chip written with at least one redundant set of data and; comprising the steps of,
reading at least a portion of at least one the redundant data sets on the memory chip of the RFID device;
adjusting a power level of the reader and comparing at least one of the redundant data sets read from the chip.

16. The method of claim 15, further comprising the step of, deleting one or more partial or whole sets of data in the memory of the chip.

17. The method of claim 15, further comprising the steps of, determining whether any of the data has been corrupted, and correcting at least part of the corrupted data.

18. The method of claim 15, authenticating the RFID device at least in part based on the step of comparing the redundant data read from the chip.

19. A system for optimizing information between RFID components, comprising,
an RFID device comprising a memory chip written with at least one redundant set of data;
an RFID reader that is a predetermined distance from the RFID device; and
an operating subsystem that:
initiates the reader to read at least a portion of at least one the redundant data sets on the memory chip of the RFID device; and
compares at least one of the redundant data sets read from the chip.

20. The system of claim 19, wherein the operating subsystem further adjusts a power level of the reader based at least in part on a variation between the predetermined distance and the post-reading distance

21. The system of claim 19, wherein the operating system further deletes one or more whole or partial redundant sets of data in the memory of the chip.

22. The system of claim 19, wherein the RFID device is an RFID sensor.

23. The system of claim 19, wherein the RFID device is an RFID tag.

24. The system of claim 19, wherein the operating system further authenticates the RFID device at least in part based on the comparison of the redundant data read from the chip.

25. The system of claim 19, wherein the operating system further determines whether the RFID device has been exposed to gamma radiation at least in part by the comparison of at least one of the redundant data sets read from the chip

26. The system of claim 19, wherein the operating system further determines that the RFID device has been exposed to gamma radiation by determining whether any of the data has been corrupted, and corrects at least part of the corrupted data.

27. The system of claim 19, wherein the operating system further determines whether any of the data has been corrupted, and corrects at least part of the corrupted data.
